(19) United States
(12) Patent Application Publication
(10) Pub. No.: US 2022/0204707 A1
(43) Pub. Date: Jun. 30, 2022

(54) THERMOPLASTIC COMPOSITE MATERIAL

(71) Applicant: NABORE GmbH, Tittling (DE)

(72) Inventor: Ewald WILKA, Unterschneidheim (DE)

(73) Assignee: NABORE GmbH, Tittling (DE)

(21) Appl. No.: 17/603,307

(22) PCT Filed: Mar. 18, 2020
(86) PCT No.: PCT/EP2020/057514

§ 371 Date: Oct. 12, 2021

(30) Foreign Application Priority Data
Apr. 15, 2019 (DE) 10 2019 109 954.4

(51) Int. Cl. C08J 5/04; C08L 89/06; C08L 67/06; C08L 7/02

(52) U.S. Cl. CPC C08J 5/045; C08L 89/06; C08L 67/06; C08L 2203/16; C08J 2425/08; C08J 2433/08; C08L 7/02

(57) ABSTRACT

The present invention relates to a thermoplastic composite material comprising an organic fibrous material and a thermoplastic binding agent, wherein the thermoplastic binding agent is selected from a polymer from the group comprising styrene-acrylate. Furthermore, the invention relates to a method for producing a thermoplastic composite material and to the use of the thermoplastic composite material.

The present invention relates to a thermoplastic composite material containing at least one organic fibrous material and at least one thermoplastic binding agent, wherein the thermoplastic binding agent is selected from a polymer from the group comprising a styrene acrylate. Furthermore, the invention relates to a method for producing a thermoplastic composite material and to a use of the thermoplastic composite material.

The designation “thermoplastic composite material” should be understood as a compound material or composite material (composite or compound for short) or a material comprising two or more connected materials which are produced by embedding a basic material, present in the form of fibres, for example, into a second substance, a so-called matrix. A solution of the individual basic materials amongst one another does not take place here or at least only superficially.

The matrix comprises a thermoplastic composite material which can be selected, for example, from the group of polymers. The thermoplastic composite material in this case has different material properties than its individual components. Substantially substance properties of the components are important for the properties of the composite material.

A thermoplastic composite material can, for example, be a fibrous material produced from a two-dimensional structure of fibres and thermoplastic binding agents. This frequently comprises leather fibres which are connected jointly with the thermoplastic binding agents to form a leather fibrous material (LEFA). These leather fibrous materials can be produced, for example, from trimming and punching residues and subsequent defibration of leather residues.

The leather itself has no thermoplastic properties such as, for example, a sufficient elasticity, flexibility and resilience and binding agents with thermoplastic properties are added to this when producing thermally deformable composite materials, in particular for leather fibrous materials. Here it is important, however, that the composite material still has leather-like properties.

The deformability of leather fibrous materials is usually achieved in a very work-intensive and energy-intensive process. Here the leather fibrous material is softened in water, punched out after about 24 hours, brightened, hot-deformed mechanically under pressure, coated with a dispersion and dried.

A precisely fitting deformation of the composite material then takes place by thermal activation, i. e. by heating to a temperature above the flow transition limit or above the thermal deformation temperature.

For thermoplastic composite materials known in the prior art, so far a so-called soft binding agent such as, for example, natural latex or a synthetic, non-thermoplastic binding agent is mixed with a hard binding agent such as, for example, polyvinyl acetate.

The hard binding agent is in this case responsible for the thermoplasticity, the soft binding agent is responsible for the elasticity or rupture safety which is why two components were always required. As a result of the high minimum film-binding temperature (MFT) of >30° C. in the case of polyvinyl acetate, for example, the thermoplasticity temperature of the composite material could additionally not be set below 70° C. which is responsible for a high energy expenditure for its thermal deformation.

It is therefore the object of the present invention to provide a thermoplastic composite material which only requires one thermoplastic component and through which the energy expenditure or the temperature for the thermoplastic deformability can be lowered.

This object is achieved by a thermoplastic composite material according to claim 1 and by a method for producing a thermoplastic composite material according to claim 12 (hereinafter also called “manufacturing method”) and a thermoplastic composite material for use according to claim 14.

A thermoplastic composite material according to the invention comprises in its simplest form

a) at least one organic fibrous material or a mixture of two or more organic fibrous materials, wherein the organic fibrous material or the mixture of two or more organic fibrous materials preferably comprises a fraction of at least 40 wt. %, particularly preferably of at least 50 wt. %, in particular of at least 60 wt. % and/or of at most 80 wt. %, in particular of at most 70 wt. % in the thermoplastic composite material
and
b) at least one thermoplastic binding agent,
wherein the thermoplastic binding agent is selected from a polymer from the group comprising or consisting of a styrene-acrylate copolymer,
and
wherein the thermoplastic binding agent preferably comprises a fraction of at least 15. wt. %, in particular of at least 20 wt. % and/or of at least 50 wt. %, in particular of at most 40 wt. %, in the thermoplastic composite material.

In the present case, “composite material” or “composite substance” is designated as a multiphase or mixed substance which consists of at least two main components: of the fibres reinforcing the composite material and a “matrix” which embeds the fibres as filler and/or adhesive. As a result of mutual interactions of the two components, the complete substance can advantageously form higher-quality properties than that of the two components involved themselves.

The term “organic fibrous material” is to be understood as a fibrous material, i. e. a linear, elementary structure which consists of a fibrous material and whose at least outer fibrous form has substantially a longitudinal shape and which comprises at least one organic component. This is understood as both naturally obtained or naturally obtainable fibres, wherein synthetically produced fibres are also included as long as these are based on an organic base. That is, the organic fibrous material can already occur naturally in the fibrous state and/or it can be transferred into a fibrous structure by one treatment step. Among natural materials, both plant and also animal organic fibrous materials are suitable for this.

In principle, any fibrous material which gives the thermoplastic composite material the desired properties such as, for example, a specific haptic or appearance, is suitable as organic fibrous material.

The content details mentioned in the present case for the components of the thermoplastic composite material (in weight percent: wt. %) relate to the total weight of the thermoplastic composite material unless noted otherwise.

The thermoplastic composite material comprises at least one thermoplastic binding agent which forms the matrix of the thermoplastic composite material and is selected from a heteropolymer, designated in the present case as copolymer. The heteropolymer or copolymer can in this case be configured as a terpolymer.

The term “heteropolymer” or “copolymer” is to be understood in the present case as a polymer which is composed of two or more different monomer units. However, the different monomer units can be similar.

Copolymers can in principle be divided into different classes: statistical copolymers in which the distribution of the two monomers in the chain is random; gradient copolymers which in principle are similar to statistical copolymers in which, however, the fraction of the one monomer increases in the course of the chain and the fraction of the other monomer decreases; alternating copolymers in which the two monomers alternate; block copolymers and segment copolymers which consist of longer sequences or blocks of each monomer (depending on the number of blocks we also talk of diblock copolymer, triblock copolymer etc.); graft copolymers in which blocks of a monomer are grafted onto the framework (backbone) of another monomer.

Copolymers which consist of three different monomers are called terpolymers. This group of copolymers can also be divided into the classes listed above.

According to the invention, the copolymer is selected from a styrene-acrylate copolymer. Acrylates are obtained by homo- or copolymerization of (meth)acrylic acid esters. Styrene (syn. vinyl benzene, according to the IUPAC nomenclature, phenylethene) is an unsaturated aromatic hydrocarbon and can be obtained by homo- or co-polymerization of vinyl benzene or phenylethene. A suitable styrene-acrylate copolymer can be obtained, for example, under the designation Acronal 2412 from BASF (Ludwigshafen, Germany).

Advantageously, by means of such a copolymer in the thermoplastic composite material according to the invention compared to the thermoplastic composite materials known from the prior art, the thermal deformation temperature or the temperature above the flow transition limit and therefore the temperature range for its thermal treatment can be lowered, as for example for deep drawing with the result that a significant energy saving can be achieved.

Furthermore, it is sufficient to add only one component as thermoplastic binding agent, namely a binding agent from the group of styrene-acrylate so that the use of two or more different components can advantageously be dispensed with.

The term “thermoplastic binding agent” stands in the present case for the entire fraction of the styrene-acrylate copolymer regardless of how many components this consists and how many different preparations this comprises.

Furthermore, the present invention comprises a method for producing a thermoplastic composite material comprising the following steps:

i) preparing an organic fibrous material or a mixture of two or more organic fibrous materials,
ii) adding a thermoplastic binding agent to the constituent/s from step i) and subsequently mixing to obtain a dispersion, wherein the thermoplastic binding agent is selected from the group comprising or consisting of a heteropolymer of acrylate and styrene,
iii) optionally adding an aqueous solution of an aluminium and/or a copper salt to the dispersion from step ii),
iv) optionally dewatering the mixture from step iii)
v) optionally drying the mixture from step iv).

The preparation of an organic fibrous material or a mixture of two or more organic fibrous materials can be accomplished in principle so that this is obtained as a correspondingly fabricated material or is also fabricated itself.

A preferred method uses prepared leather. The preparation of a leather here comprises working steps which configure the surface appearance of the leather and can influence its surface properties. The preparation usually comprises the colour design of the surface colouration but also impregnation, wax preparation or mechanical processing steps such as pressing or imprinting the leather. Wet preparation describes previous work steps in the tannery.

After preparation of the organic fibrous material, this is mixed with the thermoplastic binding agent which is selected from the group of styrene-acrylates with the result that a preferably homogeneous mixture or dispersion is obtained.

Subsequently, the dispersion can optionally be mixed with an aqueous solution of an aluminium and/or copper salt. Preferably, aluminium sulphate is used for this purpose. The inorganic salts are used in this case for precipitating the thermoplastic binding agent. In the course of the production process usually the largest fraction of the metal salt is removed with the aqueous phase from the composite material but a small residue can remain in the composite material.

In a further step, a dewatering and drying of the mixture can take place.

The quantities of the organic fibrous material or the thermoplastic binding agent are provided in this case so that after production of the thermoplastic composite material, these preferably yield a fraction as depicted above.

Furthermore, the present invention relates to a thermoplastic composite material wherein the thermoplastic composite material can be obtained using the method of manufacture described above.

Finally, the present invention relates to the use of the thermoplastic composite material according to the invention for profile cladding of wall, floor and ceiling panels, for surface coating of furniture fronts with or without inner radii, for edge banding, in particular for surface coating of parts in interiors of motor-driven vehicles.

At temperatures within the advantageous thermal deformation temperature, the thermoplastic composite material according to the invention can undergo form changes, for example, precisely contoured mouldings which are maintained in a dimensionally stable form after falling below the thermal deformation temperature.

Thus, a composite material according to the invention can, for example, be used as a decorative strip or in the form of various applications which are usually formed from plastic, wood or piano lacquer, with the result that a very lively appearance or an individual design of the interior of motor-driven vehicles can be obtained.

Since the thermoplastic binding agent is contained in the composite material according to the invention and the thermal activation of the binding agent takes place in the temperature range above the thermal deformation temperature of the composite material, furthermore an adhesive bonding of the thermoplastic composite material with a lining material and/or outer material such as a nonwoven, for example, can be accomplished. Advantageously, an adhesive bonding with such a nonwoven enables an improvement in the stitch tear strength, in particular with regard to sewing of the advantageous thermoplastic composite material.

Further particularly advantageous configurations and further developments of the invention are obtained from the dependent claims and from the following description, wherein the independent claims of one claim category can also be further developed similarly to the dependent claims and exemplary embodiments or description parts of a different claim category and also individual features of various exemplary embodiments or variants can be combined to form new exemplary embodiments or variants.

According to a preferred embodiment, the styrene-acrylate copolymer comprises a fraction of acrylate of above 50 wt. %. Particularly preferably the styrene-acrylate copolymer comprises a fraction of acrylate of at least 60 wt. %, in particular of at least 70 wt. %, in the styrene-acrylate copolymer. The fraction of styrene in the copolymer is at most 40 wt. %, particularly preferably at most 30 wt. %.

The acrylate component or the acrylate polymer can use homopolymers or copolymers which in addition to acrylic acid esters (acrylates), for example, comprise acrylonitrile, vinyl acetate, vinyl propionate, vinyl chloride and/or vinylidene chloride.

Preferred monomers for producing the acrylate polymer are selected from methacrylate, ethylacrylate, n-butylacrylate, isobutylacrylate, tert.-butylacrylate, hexylacrylate, 2-ethylhexylacrylate and/or laurylacrylate. Optionally, additional monomers such as acrylic acid, methacrylic acid, acrylamide and/or methacrylamide can be added during the polymerization.

The acrylate components can also comprise acrylates and/or methacrylates having one or more functional groups such as, for example, maleic acid, itaconic acid, butane dioldiacrylate, hexane dioldiacrylate, triethylene glycol diacrylate, tetraethylene glycol diacrylate, neopentyl glycol diacrylate, trimethylol propane triacrylate, 2-hydroxyethyl acrylate, 2-hydroxyethyl methacrylate, hydroxypropyl acrylate, propylene glycol methacrylate, butanediol monoacrylate, ethyl diglycol acrylate as well as 2-acrylamido-2-methylpropane sulfonic acid.

The fraction of the styrene-acrylate copolymer in the thermoplastic composite material is preferably at least 20 wt. % and/or at most 40 wt. %.

In addition to the advantageous styrene-acrylate copolymer, further binding agents can also serve as matrix of the composite material. Preferably, polymeric materials are used for this purpose. In this respect, in addition to the styrene-acrylate copolymer, further binding agents are used but the styrene-acrylate copolymer preferably comprises a fraction of at least 90 wt. % of the total fraction of the binding agent.

According to a further preferred embodiment, the fraction of organic fibrous fraction in the thermoplastic composite material is at least 60 wt. % and/or at most 80 wt. %.

In principle, a styrene-acrylate copolymer in the advantageous thermoplastic binding agent from a molecular mass of about 1 000 Da is suitable. A preferred molecular mass of the styrene-acrylate copolymer present in the thermoplastic binding agent is however at least 5 000 Da, preferably at least 7 500 Da, in particular at least 10 000 Da and/or at most 500 000 Da, preferably at most 100 000 Da, particularly preferably at most 50 000 Da, in particular at most 30 000 Da.

The determination of the molecular mass of polymers is known in principle to the person skilled in the art and can be determined, for example, by gel permeation chromatography (GPC).

According to a further preferred embodiment, the composite material comprises at least one material which is selected from a natural and/or synthetic latex, preferably from a natural latex. Natural and/or synthetic latex is a material which is produced by foaming natural or synthetic rubber. Natural rubber (also called rubber in everyday language) is also designated as Gummi elasticum or Resina elastica and is a rubber-like substance in the milky sap of rubber plants. In particular, crude oil is used as raw material for synthetically produced rubber.

Preferably the total fraction of the binding agent and of the natural and/or synthetic latex in the composite material is at least 30 wt. % and/or at most 60 wt. %, in particular at least 30 wt. % and/or at most 50 wt. %.

A preferred method for producing such a composite material therefore additionally takes into account the additional of a natural and/or synthetic latex in addition to the steps already mentioned above.

Preferably, the styrene-acrylate copolymer has a minimum film-forming temperature (MFT) of at most 1° C., preferably of at most 0° C. A styrene-acrylate copolymer having such a minimum film-forming temperature advantageously gives the composite material optimal elasticity properties and a high rupture safety.

The designation minimum film-forming temperature means the lowest temperature at which a thin layer of a polymer dispersion still dries to form a cohesive film. It is close to the glass transition temperature T_{g} of the polymer and with the film formation determines one of the most important application-technical properties of a polymer dispersion. A method for determining the minimum film-forming temperature is known to the person skilled in the art and can, for example, be accomplished according to DIN 53787.

Preferably, the thermoplasticity temperature of the composite material can be reduced by such a styrene-acrylate copolymer to a deformation temperature of about 50° C. to at most 80° C., particularly preferably to about 65° C., in particular of about 50° C., with the result that the energy expenditure for a thermal deformation can be significantly reduced. A thermal deformation can in particular comprise the process of deep drawing.

Depending on the use of the advantageous composite material, its properties can be further modified. Thus, a further preferred composite material can contain up to 20 wt. % of one or more components from the group comprising inorganic salts, preservatives, colourants, natural and/or synthetic fats, paraffins, natural and/or synthetic oils, silicone oils, ionic and/or non-ionic tensides.

In principle, plastic fibres, plant fibres or animal fibres can be used for the advantageous thermoplastic composite material. Suitable animal fibres comprise natural fibres such as wool, hair or silk; plant fibres can for example include, cotton, kapok, flax, hemp, jute, kenaf, ramie, broom, manila, coconut or sisal. Suitable plastic fibres can be selected from natural polymers such as cupro, viscose, modal, acetate, triacetate and protein fibres or alginate fibres or mixtures of two or more of said fibres.

As examples of suitable fibres from synthetic polymers, mention may be made of polyacrylic, polymethacrylic, polyvinylchloride, fluorine-containing polymer fibres, polyethylene, polypropylene, vinylacetate, polyacrylonitrile, polyamide, polyester or polyurethane fibres.

Particularly preferably, the organic fibrous material comprises plastic fibres, plant fibres and/or animal fibres. In particular, the organic fibrous material comprises leather fibres.

Within the scope of the present invention, the leather fibres are preferably selected from prepared leather. The leather fibres can here in principle be obtained from any type of prepared leather residues such as, for example, from chrome-tanned, vegetal-tanned and/or aldehyde-tanned leather or pre-products thereof such as, for example, shavings or split leathers. Types of leather which can be used within the scope of the present invention are, for example, upper leather, velour leather, crust leather, sole leather, lining leather, blank leather and technical leather. In particular, the prepared leather comprises leather with at least one colour component or a preferably surface colour layer.

Depending on the desired visual or mechanical properties, the organic fibrous material is comminuted to a stretched length of generally about 0.1 to 20 mm. Insofar as the organic fibres are selected from leather fibres, the fibre length is preferably at least about 0.5 mm, particularly preferably about 1 mm, in particular about 3 mm. At most, a preferred fibre length is up to about 20 mm, particularly preferably up to about 10 mm, in particular up to about 8 mm. The fibre length is measured in this case in the stretched state of the fibre; depending on the type of starting material and type of comminution it can occur that the fibre without external influencing adopts an irregular, for example, a curved shape.

According to a further preferred embodiment, the advantageous thermoplastic composite material comprises a thermally activatable adhesive, preferably a hot-melt adhesive. After activation at a temperature at which the adhesive or the hot-melt adhesive softens or goes over into the liquid state, such a thermally activatable adhesive or preferred hot-melt adhesive forms a firm connection with the organic fibrous material or completely and resistantly adheres to this. Due to a subsequent cooling, the adhesive solidifies and thus remains firmly connected to the organic fibrous material even under high mechanical loading.

The term “hot-melt adhesive” (also called hot adhesive, hot glue, hot melt or hot glue) is generally understood as a solvent-free substance that is more or less solid at room temperature, which liquefies in the heated state at the melting temperature thereof and during cooling forms a firm connection, in the present case with the organic fibres and optionally further substances which are located in the advantageous composite material. This group of adhesives is based on various chemical raw materials. Preferably the melting temperature of such a hot-melt adhesive lies within the thermal deformation temperature of the thermoplastic composite material.

The thermally activatable adhesive or the preferred hot-melt adhesive can in this case be formed by the thermoplastic binding agent itself, i.e. the styrene-acrylate copolymer. Alternatively, the thermally activatable adhesive or the hot-melt adhesive can also be selected from another substance. Such an alternative substance can, for example, be selected from the group of polyamide, polyethylene, polyalphaolefin, ethylene vinylacetate copolymers, polyester elastomers, copolyamide elastomers, vinylpyrrolidone/vinylacetate copolymers and the like.

In addition to the use of the thermoplastic composite material according to the invention which has already been explained initially, this can be used in principle to produce various thermally formable components such as, for example, thermally formable shoe components such as rear caps and/or front caps, sheathing of objects such as, for example, sheathing of boxes, perfume containers and the like, leather linings of containers and caskets etc.

Further features of the invention are obtained from the following description of the exemplary embodiment in conjunction with the claims. It should be pointed out that the invention is not restricted to the embodiment of the exemplary embodiment described but is determined by the scope of the appended claims. In particular, the individual features of the embodiment according to the invention can be implemented in a different combination than in the example listed hereunder.

### EXAMPLE

### Example 1

Production of the Thermoplastic Composite Material According to the Invention:

In order to produce the thermoplastic composite material according to the invention, firstly, leather in the dry state is comminuted into 5-10 mm² pieces using a fine cutting mill (Netzsch Feinmahltechnik, Selb, Germany) in 5-10 mm². Both prepared and non-prepared leather can be used as leather starting material. The comminuted leather is mixed with water (2-5 wt. % leather and 95-98 wt. % water) and ground within 2-10 hours using an Asplund disk refiner (Valmet, Darmstadt, Germany) to obtain a knot-free fibre pulp.

The fibre pulp thus obtained (water fraction 97-99 wt. %) is mixed in batches (400-700 kg fibres per batch) with 40 wt. % styrene-acrylate copolymer (percentage calculated for the dry fibres, Acronal 2412, BASF, Ludwigshafen, Germany; pH 6 to 8, MFT<1° C., dynamic viscosity: 90-200 mPa·s (23° C., 250 1/s; DIN EN ISO 3219), solid fraction: 56.0-58.0% (DIN EN ISO 3251), particle size range: <0.1 μm-10 μm) and subsequently coagulated with an aluminium sulphate solution (7-10%), and agitated for about one hour. The fibre pulp is then dewatered on a Fourdrinier dewatering machine (made by Corsini), dried whilst supplying warm air in a drying channel (made by Dornier), calendered in a rolling mill (e. g. Aletti (Varese)), polished and further refined. The refinement can be accomplished, for example, by embossing on the surface and preparation with dye.

The composite material according to the invention has a deformation temperature in the range from 50 to 65° C.

It is finally pointed out once again that the devices described in detail hereinbefore merely comprise exemplary embodiments which can be modified by the person skilled in the art in various ways without departing from the range of the invention. Furthermore, the use of the indefinite article “a” or “an” does not exclude the fact that the relevant features can also be present in multiples. Also, the terms “constituent” or “component” do not exclude the fact that these can also consist of several interacting partial components.

1. Thermoplastic composite material containing
a) at least one organic fibrous material or a mixture of two or more organic fibrous materials, wherein the organic fibrous material or the mixture of two or more organic fibrous materials preferably comprises a fraction of at least 40 wt. %, particularly preferably of at least 50 wt. %, in particular of at least 60 wt. % and/or of at most 80 wt. %, in particular of at most 70 wt. %, in the thermoplastic composite material
and
b) at least one thermoplastic binding agent,
wherein the thermoplastic binding agent is selected from a copolymer from the group comprising or consisting of one of styrene-acrylate,
and
wherein the thermoplastic binding agent preferably comprises a fraction of at least 15 wt. %, in particular of at least 20 wt. % and/or of at least 50 wt. %, in particular of at most 40 wt. %, in the thermoplastic composite material.

2. Composite material according to claim 1, wherein the copolymer comprises a fraction of acrylate of at least 60 wt. % and/or wherein the copolymer comprises a fraction of styrene of at most 40 wt. %.

3. Composite material according to claim 1, wherein the styrene-acrylate copolymer has a molecular mass of at least 5 000 Da, preferably of at least 7 500 Da, in particular of at least 10 000 Da and/or of at least 500 000 Da, preferably of at most 100 000 Da, particularly preferably of at most 50 000 Da, in particular of at most 30 000 Da.

4. Composite material according to claim 1, wherein the composite material comprises at least one material which is selected from a natural and/or synthetic latex, preferably from a natural latex.

5. Composite material according to claim 1, wherein the total fraction of the binding agent and of the natural and/or synthetic latex in the composite material is at least 30 wt. % and/or at most 60 wt. %, in particular at least 30 wt. % and/or at most 50 wt. %.

6. Composite material according to claim 1, characterized in that the styrene-acrylate copolymer contains at least one polymer which has a minimum film-forming temperature (MFT) of at most 1° C., preferably of at most 0° C.

7. Composite material according to claim 1, characterized in that the composite material has a thermal deformation temperature of about 50° C. and/or of at most 80° C., preferably of about 65° C., in particular of about 50° C.

8. Composite material according to claim 1, characterized in that the composite material contains up to 20 wt. % of one or more components selected from the group consisting of inorganic salts, preservatives, colourants, natural and/or synthetic fats, paraffins, natural and/or synthetic oils, silicone oils, ionic and/or non-ionic tensides.

9. Composite material according to claim 1, characterized in that the organic fibrous material comprises plastic fibres, plant fibres and/or animal fibres, preferably leather fibres.

10. Composite material according to claim 1, wherein the organic fibrous material comprises leather fibres, preferably leather fibres of prepared leather.

11. Composite material according to claim 1, characterized in that the material is provided with a thermally activatable adhesive, preferably with a hot-melt adhesive.

12. Method for producing a thermoplastic composite material comprising the steps:
i) preparing an organic fibrous material or a mixture of two or more organic fibrous materials,
ii) adding a copolymer to the constituent/s from step i) and subsequently mixing to obtain a dispersion, wherein the copolymer comprises at least one acrylate and at least one styrene,
iii) optionally adding an aqueous solution of an aluminium and/or a copper salt to the dispersion from step ii),
iv) optionally dewatering the mixture from step iii)
v) optionally drying the mixture from step iv).

13. Thermoplastic composite material, wherein the thermoplastic composite material can be obtained using a method according to claim 12.

14. A method using a thermoplastic composite material according to claim 1 for profile cladding of wall, floor and ceiling panels, for surface coating of furniture fronts with or without inner radii, for edge banding, in particular for surface coating of parts in interiors of motor-driven vehicles.

15. A method of using a thermoplastic composite material produced according to claim 12 for profile cladding of wall, floor and ceiling panels, for surface coating of furniture fronts with or without inner radii, for edge banding, in particular for surface coating of parts in interiors of motor-driven vehicles.

16. A method of using a thermoplastic composite material able to be produced according to claim 13 for profile cladding of wall, floor and ceiling panels, for surface coating of furniture fronts with or without inner radii, for edge banding, in particular for surface coating of parts in interiors of motor-driven vehicles.
